(19) United States
(12) Patent Application Publication
(10) Pub. No.: US 2007/0192589 A1
(43) Pub. Date: Aug. 16, 2007

(54) SYSTEM AND METHOD FOR ENCRYPTING WEBPAGE LOGS

(75) Inventors: CHUNG-I LEE, Tu-Cheng,Taipei Hsien (TW); CHIEN-FA YEH, Tu-Cheng,Taipei Hsien (TW); CHIU-HUA LU, Tu-Cheng,Taipei Hsien (TW); BOR-CHUAN LIN, Tu-Cheng,Taipei Hsien (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng,Taipei Hsien (TW)

(21) Appl. No.: 11/563,154

(22) Filed: Nov. 25, 2006

(30) Foreign Application Priority Data
Feb. 11, 2006 (CN) 200610033625.3

(51) Int. Cl. H04L 9/00

(52) U.S. Cl. 713/156

(57) ABSTRACT

A system for encrypting webpage logs is disclosed, the system includes: a log packing module (201) configured for packing the webpage logs in a webpage packing file, a message digest generating module (202) configured for performing a message digest operation, an encrypting module (203) configured for encrypting the message digest and a corresponding digital signature, a digital signature checking module (204) configured for checking the digital signature, and a recording module (205) configured for recording the webpage packing file, the message digest and the digital signature. A related method is also disclosed.

### BACKGROUND OF THE INVENTION

1. Field of the Invention

The present invention relates to a system and method for encrypting webpage logs.

2. Description of related art

The Internet has provided its users with a mechanism for reducing communication costs by distributing maintenance costs of the network amongst a number of different network servers. This mechanism has provided the Internet with a distinctly “open” character, creating an undesired result that webpage logs transmitted over the Internet can be intercepted by parties other than the intended recipients, altered by the intercepting parties, and then transmitted back to the intended recipients without the recipients having knowledge of the alteration. This weakness can be particularly problematic, particularly for parties engaged in e-commerce transactions over the Internet, since the terms of an order can be altered by a third party without authorization from the ordering party. Similarly, credit card numbers, bank account numbers, and/or other financial information necessary for completion of e-commerce transactions can be intercepted and used by malicious parties to generate unauthorized orders for goods or services.

To address this problem, the concept of a digital signature was developed as a means for allowing recipients of webpage logs to verify the authenticity of the electronic document. Using the digital signature associated with the webpage logs' originator cannot insure the webpage logs' security.

Therefore, what is needed is a system and method for encrypting webpage logs, by which the webpage logs' security can be insured.

### SUMMARY OF THE INVENTION

A system for encrypting webpage logs includes: a log packing module configured for packing the webpage logs in a webpage packing file; a message digest generating module configured for performing a message digest operation on the webpage packing file to generate a message digest of the webpage packing file; an encrypting module configured for encrypting the message digest and a corresponding digital signature with a cryptograph; a digital signature checking module configured for checking the digital signature to determine whether the digital signature is valid; and a recording module configured for recording the webpage packing file, the message digest and the digital signature, and returning a success message indicating that the webpage logs are encrypted successfully, if the digital signature checking module determines the digital signature is valid.

A related method for encrypting webpage logs includes the steps of: packing the webpage logs in a webpage packing file; performing a message digest operation on the webpage packing file to generate a message digest of the webpage packing file; encrypting the message digest and a corresponding digital signature with a cryptograph; checking the digital signature to determine whether the digital signature is valid; and recording the webpage packing file, the message digest and the digital signature, and returning a success message indicating that the webpage logs are encrypted successfully, if the digital signature is valid.

Other advantages and novel features of the embodiments will be drawn from the following detailed description with reference to the attached drawings.

### BRIEF DESCRIPTION OF THE DRAWINGS

FIG. 1 is a schematic diagram of hardware configuration of a system for encrypting webpage logs in accordance with a preferred embodiment; and

FIG. 2 is a flowchart of a preferred method for encrypting webpage logs by utilizing the system of FIG. 1.

### DETAILED DESCRIPTION OF THE INVENTION

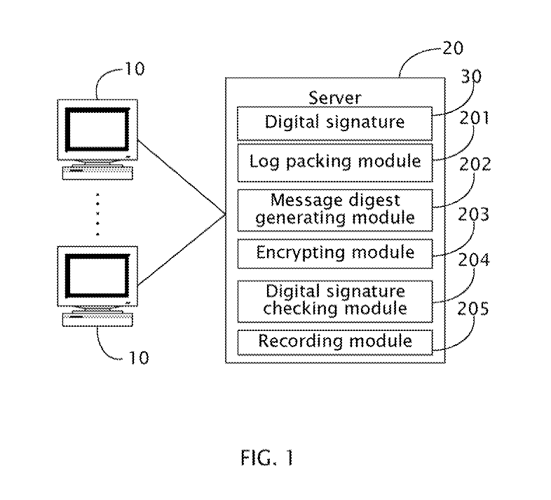

FIG. 1 is a schematic diagram of hardware configuration of a system for encrypting webpage logs (hereinafter, “the system”) in accordance with a preferred embodiment. The system includes: a plurality of client-computers 10 and a server 20. The webpage logs are files created and edited by a user, and may contain different characters and/or images. Each client computer 10 may be a personal computer (PC), a notebook computer, or the like.

Typically, the server 20 stores a digital signature 30, and includes a log packing module 201, a message digest) generating module 202, an encrypting module 203, a digital signature checking module 204, and a recording module 205.

The digital signature 30 is typically an image file, and is comparative with a signature manually signed by the user. The digital signature 30 generally includes signature time stamp, signature validity period, signature owner, and so on. The signature time stamp is a time the digital signature 30 was created. The signature validity period is a time duration when the digital signature 30 is valid and usable.

The log packing module 201 is configured for packing the webpage logs in a webpage packing file. For example, the log packing module 201 may link the webpage logs to the webpage packing file, or merge the webpage logs into the webpage packing file.

The message digest generating module 202 is configured for performing a message digest operation (for example, Message Digest Algorithm 4 (MD4), Message Digest Algorithm 5 (MD5), or the like) on the webpage packing file to generate a message digest of the webpage packing file. For example, if the MD5 is adopted to perform the message digest operation on the webpage packing file, a 128 bits alphanumerical string will be generated as the message digest of the webpage packing file.

The encrypting module 203 is configured for encrypting the message digest and the digital signature 30 with a cryptograph. For example, an algorithm called Dissymmetrical Encryption Algorithm (DEA) can be used to encrypt the message digest and the digital signature 30. If the DEA is adopted to encrypt the message digest and the digital signature 30, a public key is created to encrypt the message digest and the digital signature, and a private key is created to deciphered an encryption of the message digest and the digital signature.

The digital signature checking module 204 is configured for checking the digital signature 30 to determine whether the digital signature 30 is valid. As mentioned previously, the digital signature 30 is recorded in the server 20, if the DEA is adopted to encrypt the message digest and the digital signature 30, the digital signature checking module 204 must use the private key to decipher the encryption. Afterwards, the digital signature checking module 204 checks the deciphered digital signature 30, and determines whether the deciphered digital signature 30 is valid. Namely, the digital signature checking module 204 checks the signature time stamp, the signature validity period, and the signature owner of the digital signature 30. For example, if the signature validity period has expired, the digital signature checking module 204 determines the digital signature 30 after deciphering the encryption is not valid.

The recording module 205 is configured for recording the webpage packing file, the message digest, and the digital signature. The recording module 205 is further used for returning a success message indicating that the webpage logs are encrypted successfully if the digital signature checking module 204 determines the digital signature is valid. Also, if the digital signature checking module 204 determines the digital signature is not valid, the recording module 205 is configured for returning an error message indicating that the webpage logs are encrypted unsuccessfully.

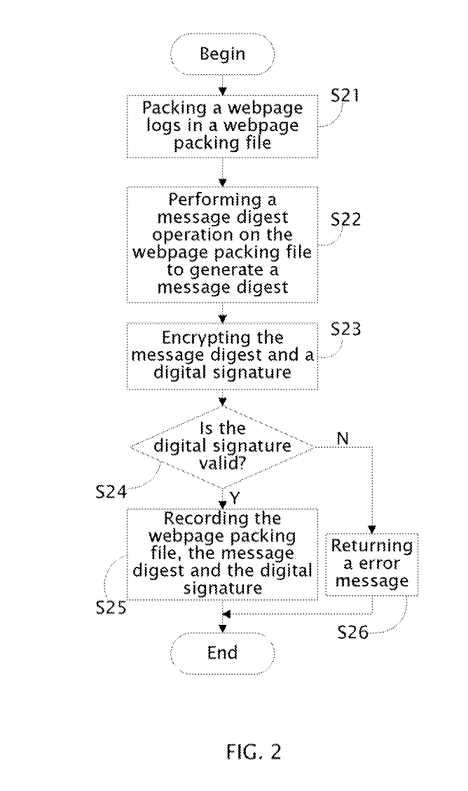

FIG. 2 is a flowchart of a preferred method for encrypting webpage logs by utilizing the system of FIG. 1. In instructional step S21, the log packing module 201 packs the webpage logs in a webpage packing file. In instructional step S22, the message digest generating module 202 performs a message digest operation on the webpage packing file to generate a message digest of the webpage packing file. In instructional step S23, the encrypting module 203 encrypts the message digest and the digital signature 30 with a cryptograph. In instructional step S24, the digital signature checking module 204 checks the digital signature 30 to determine whether the digital signature 30 is valid. If the digital signature 30 is valid, in instructional step S25, the recording module 205 records the webpage packing file, the message digest, and the digital signature, the recording module 205 further returns a success message indicating that the webpage logs are encrypted successfully. Otherwise, if the digital signature 30 is not valid, in instructional step S26, the recording module 205 returns an error message indicating that the webpage logs are encrypted unsuccessfully.

Although the present invention has been specifically described on the basis of a preferred embodiment and preferred method, the invention is not to be construed as being limited thereto. Various changes or modifications may be made to the embodiment and method without departing from the scope and spirit of the invention.

What is claimed is:

1. A system for encrypting webpage logs, the system comprising:
a log packing module configured for packing the webpage logs in a webpage packing file;
a message digest generating module configured for performing a message digest operation on the webpage packing file to generate a message digest of the webpage packing file;
an encrypting module configured for encrypting the message digest and a corresponding digital signature with a cryptograph;
a digital signature checking module configured for checking the digital signature to determine whether the digital signature is valid; and
a recording module configured for recording the webpage packing file, the message digest and the digital signature, and returning a success message indicating that the webpage logs are encrypted successfully, if the digital signature checking module determines the digital signature is valid.

2. The system according to claim 1, wherein the recording module is further configured for returning an error message indicating that the webpage logs are encrypted unsuccessfully, if the digital signature checking module determines the digital signature is not valid.

3. A computer-based method for encrypting webpage logs, the method comprising the steps of:
packing the webpage logs in a webpage packing file;
performing a message digest operation on the webpage packing file to generate a message digest of the webpage packing file;
encrypting the message digest and a corresponding digital signature with a cryptograph;
checking the digital signature to determine whether the digital signature is valid; and
recording the webpage packing file, the message digest and the digital signature, and returning a success message indicating that the webpage logs are encrypted successfully, if the digital signature is valid.

4. The method according to claim 3, further comprising the step of:
returning an error message indicating that the webpage logs are encrypted unsuccessfully, if the digital signature is not valid.
